(19) United States
(12) Patent Application Publication
(10) Pub. No.: US 2014/0100961 A1
(43) Pub. Date: Apr. 10, 2014

(54) System for Providing Information to Client Terminal when Conducting Communication Service

(71) Applicants: Gil-soo Lee, Gyeonggi-do (KR); Do-hyung Kim, Seoul (KR); Jeong-jun Yun, Seoul (KR)

(72) Inventors: Gil-soo Lee, Gyeonggi-do (KR); Do-hyung Kim, Seoul (KR); Jeong-jun Yun, Seoul (KR)

(73) Assignee: TI SQUARE TECHNOLOGY LTD., Gyeonggi-do (KR)

(21) Appl. No.: 14/008,549

(22) PCT Filed: Mar. 28, 2012
(86) PCT No.: PCT/KR2012/002280

§ 371 Date: Dec. 6, 2013

(30) Foreign Application Priority Data
Mar. 29, 2011 (KR) 10-2011-0028061
May 20, 2011 (KR) 10-2011-0047910

(51) Int. Cl. G06Q 30/02

(52) U.S. Cl. CPC G06Q 30/0267
USPC 705/14.64

(57) ABSTRACT

The present invention relates to a system for providing information to a client terminal when conducting a communication service, and more particularly, to a system for providing information to at least one client terminal including an outgoing terminal and an incoming terminal when conducting a communication service, comprising: a call control and maintenance server for forming and maintaining a media session to conduct the communication service between the outgoing terminal and the incoming terminal; and an information maintenance server for maintaining the information to be transmitted to at least one client terminal, wherein the information maintenance server transmits to either the outgoing terminal or the incoming terminal information-related data, which is related to the information to be provided to the client terminal before the media session for the communication service between the outgoing terminal and the incoming terminal, or while the communication service is being conducted, and wherein the client terminal which receives the information-related data provides information to an information display area on the display portion of a terminal based on the information-related data.

### TECHNICAL FIELD

The present invention relates, in general, to a system for providing information to a client terminal when performing a communication service and, more particularly, to a system that is capable of providing various types of information to a client terminal while performing a communication service, such as a voice call, voice chat, video call, or video chat service, based on Internet Protocol (IP).

### BACKGROUND ART

Recently, with the development of Internet technology, mobile communication terminals equipped with a wireless local area network (WiFi)-access function, such as smart phones or tablet Personal Computers (PCs), have been rapidly popularized, and various types of communication services using such mobile communication terminals have been provided using various methods. Such mobile communication terminals have provided various types of communication services such as voice call, chat, message transfer, video call, and video chat services using, in particular, the wireless Internet, instead of using existing 2nd generation/3rd generation (2G/3G) mobile communication networks. Such communication services have been widely used in that users do not pay additional fees owing to the free use of the Internet. In particular, recently, the number of so-called Mobile Voice over Internet Protocol (mVoIP) services for providing voice call services based on the Internet Protocol (IP) of such a wireless local area network has greatly increased.

In accordance with this trend, there are required schemes for conveniently and efficiently providing information, such as advertisement information, coupon information, social commerce information, and event information, without charging users additional fees, when various types of communication services such as voice call, chat, message transfer, video call, and video chat services are performed based on the IP.

### DISCLOSURE

### Technical Problem

The present invention has been made keeping in mind the above problems, and an object of the present invention is to provide a system, which can conveniently and efficiently provide information, such as advertisement, coupon, or event information, to users when performing various types of communication services between a transmitting terminal and a receiving terminal.

Another object of the present invention is to provide an information provision system, which can distribute actual profit to users by attracting the users' interest and allowing the users to actively participate in events or the like because information such as advertisement, coupon, or event information can be displayed during the performance of a communication service.

A further object of the present invention is to provide an information provision system, which can provide various types of multimedia services while attracting users' interest, by detecting a keyword made during the communication service of each user and by displaying information corresponding to the keyword at the same time that advertisement, coupon, or event information is displayed.

Yet another object of the present invention is to provide an information provision system, which can increase the exposure time of information and concentration on information using video advertisements having excellent communicative power or keyword advertisements meeting the requirements of clients so that the characteristics of communication services desired by an advertiser or a marketer can be utilized, thus maximizing advertising or marketing effects.

### Technical Solution

In order to accomplish the above objects, the present invention provides an information provision system for providing information to at least one of client terminals including a transmitting terminal and a receiving terminal when performing a communication service, including a call control and management server for establishing and managing a media session for performing a communication service between the transmitting terminal and the receiving terminal; and an information management server for managing information to be transmitted to at least one of the client terminals, wherein the information management server transmits information-related data about information to be provided to the corresponding client terminal to at least one of the transmitting terminal and the receiving terminal, either before the media session for the communication service is established between the transmitting terminal and the receiving terminal or while the communication service is performed, and wherein the client terminal that received the information-related data provides the information to an information display area of a display unit of the client terminal based on the information-related data.

In this case, the communication service may be at least one of voice call, chat, video call, video chat, and message transfer services based on Internet Protocol (IP).

Further, the information management server may receive a request for transmission of the information-related data from the client terminal, and transmit the information-related data to the client terminal.

Furthermore, the information display area of the client terminal area may be at least part or all of a background screen of a user interface of the client terminal.

Furthermore, the client terminal may be configured such that an input interface included in a user interface of the client terminal appears and then disappears on the user interface, and the information display area is an area in which the input interface disappears.

Furthermore, the information provided to the client terminal may be an advertisement, and the information-related data may include advertisement data.

Furthermore, the information provision system may further include a keyword management server for managing keywords and keyword-related information to be transmitted to the client terminal, wherein the keyword management server transmits a keyword list and pieces of keyword information data corresponding to respective keywords included in the keyword list to at least one of the client terminals either before the media session for the communication service is established between the transmitting terminal and the receiving terminal or while the communication service is performed, and the client terminal that received the keyword list is operated to detect a keyword included in the keyword list while performing the communication service of the client terminal based on the keyword list, configure information corresponding to the detected keyword based on the keyword information data, and display the corresponding information in the information display area of the display unit of the terminal.

Furthermore, the terminal that displays the information in the information display area of the display unit may transmit corresponding keyword information data to a terminal of another party.

Furthermore, of the client terminals including the transmitting and receiving terminals, the terminal that displays the information in the information display area of the display unit may transmit image information mixed or replaced with information about the keyword, or information-related data corresponding to the keyword to a client terminal of another party.

Furthermore, the information provision system may further include an event management server coupled to the information management server and configured to manage an event allowing a user to take a specific action, wherein the information-related data includes event data allowing the user to take the specific action.

Furthermore, the information provision system may further include a reward management server coupled to the information management server and configured to collect information about use of information-related data by a terminal user of at least one of the transmitting terminal and the receiving terminal and to process a reward to the user based on collected use information.

Furthermore, the information provision system may further include at least one of a keyword management server coupled to the information management server and configured to provide information-related data including a keyword list and keyword information data to the client terminal, and an event management server coupled to the information management server and configured to provide information-related data including event data that allows the user to take a specific action to the client terminal, wherein the reward management server processes a reward to the user based on at least one of use information of the information-related data based on at least one keyword included in the keyword list and use information of the information-related data based on participation in an event.

### Advantageous Effects

In accordance with the present invention, there can be provided a system, which can conveniently and efficiently provide information such as advertisement, coupon, or event information to users when performing a communication service between a transmitting terminal and a receiving terminal.

Further, in accordance with the present invention, there can be provided a type of communication service, which allows users to expect cost reduction or profit sharing by attracting the users' interest and allowing the users to participate in events because information such as advertisement, coupon, or event information can be displayed during the performance of a communication service, thus inducting users to more actively participate in the communication service without being limited to monotonous communication services.

Furthermore, in accordance with the present invention, there is the advantage of allowing users to be provided with various types of multimedia services while attracting the users' interest by detecting a keyword made during the communication service of each user and by displaying information corresponding to the keyword at the same time that advertisement, coupon, or event information is displayed.

### DESCRIPTION OF DRAWINGS

FIG. 1 is a diagram showing the state of connection between a system for providing information to a transmitting and/or receiving client terminal when performing a communication service and the client terminals according to an embodiment of the present invention;

FIG. 2 is a flowchart showing a procedure for performing a communication service between a transmitting client terminal 20 (hereinafter referred to as a “transmitting terminal”) and a receiving client terminal 30 (hereinafter referred to as a “receiving terminal”) via an information provision system 10 shown in FIG. 1;

FIG. 3 is a flowchart showing an embodiment of a method of providing information when performing a communication service between the transmitting terminal 20 and the receiving terminal 30 via the information provision system 10 shown in FIG. 1, wherein a case where information is provided only to the transmitting terminal 20 is depicted;

FIGS. 4 to 7 are diagrams showing screens when an advertisement is provided to the transmitting terminal 20 or the receiving terminal 30;

FIG. 8 is a diagram showing the configuration of a system 10 for providing information to a client terminal when performing a communication service according to another embodiment of the present invention;

FIG. 9 is a flowchart showing an embodiment of an information provision method performed by the information provision system 10 shown in FIG. 8;

FIG. 10 illustrates a screen showing a case where an advertisement is provided as information to the display unit of the transmitting terminal 20 at S960 of FIG. 9;

FIG. 11 is a diagram showing the configuration of a system 10 for providing information to a client terminal when performing a communication service according to a further embodiment of the present invention;

FIG. 12 is a diagram showing the configuration of a system 10 for providing information to a client terminal when performing a communication service according to yet another embodiment of the present invention;

FIG. 13 is a diagram showing the configuration of a system 10 for providing information to a client terminal when performing a communication service according to still another embodiment of the present invention; and

FIG. 14 is a diagram showing the principle of the principal operation of the information provision system of FIG. 13.

### BEST MODE

Hereinafter, embodiments of the present invention will be described in detail with reference to the attached drawings.

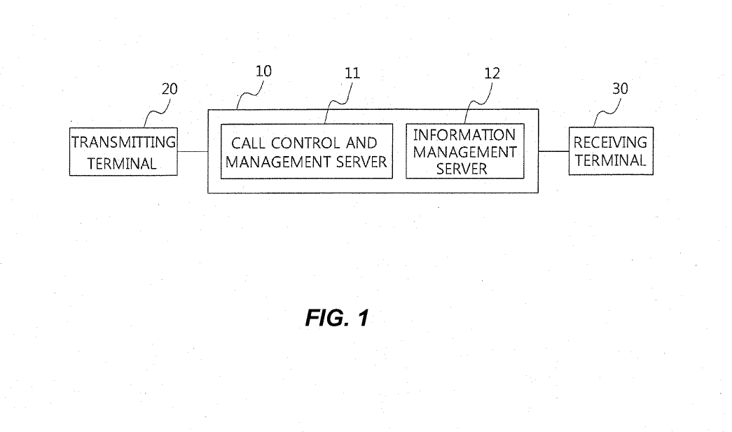

FIG. 1 is a diagram showing the state of connection between a system for providing information to client terminals when performing a communication service and the client terminals according to an embodiment of the present invention.

Referring to FIG. 1, a system 10 for providing information to client terminals when performing the communication service (hereinafter simply referred to as an ‘information provision system’) according to the present embodiment is coupled to a transmitting client terminal 20 (hereinafter simply referred to as a ‘transmitting terminal’) and a receiving client terminal 30 (hereinafter simply referred to as a ‘receiving terminal’) over the Internet.

Each of the client terminals 20 and 30 includes a mobile terminal that is usable based on Internet Protocol (IP) over the Internet or a mobile communication network, and such a mobile terminal may be implemented as a computer, a tablet PC, a smart phone, or a mobile communication terminal, which has a wireless Internet access function or a mobile communication network access function using a packet-based data network. Such a mobile terminal is coupled to the information provision system 100 based on the IP and is provided with various types of communication services, such as voice call, chat, message transfer, video call, and video chat services, through the information provision system.

For example, on each of the client terminals 20 and 30, a predetermined IP-based application program may be installed, and such an application program may execute predetermined functions while working in conjunction with the information provision system 10 on the client terminal 20 or 30 via at least one of, for example, a communication control module, an advertisement exposure image processing module, an event automatic participation module, a keyword advertisement exposure module, a screen control module, a character and speech recognition module, a video chat content management module, a video chat keyword content mixing module.

The information provision system 10 includes a call control and management server 11 and an information management server 12, by which information, such as advertisement or event information, is provided to at least one of the transmitting terminal 20 and the receiving terminal 20 when a communication service is performed between the transmitting terminal 20 and the receiving terminal 30. In this case, the information provision system 10 may be provided with an information content interworking server (not shown) for making a connection to the transmitting terminal 20 and to the receiving terminal 30.

In this case, the information content interworking server may include an Application Server (AS) module for controlling a signal processing flow and media conversion for a connection to a Session Initiation Protocol (SIP) call and an H.324M call while working in conjunction with the call control and management server 11, a Media Transcoding Server (MTS) module for performing the function of processing media conversion between an SIP call and an H.324M call, a Signaling Processing Unit (SPU) module for processing a Signaling System no. 7 (SS7) signals in a circuit switched network, a Video Processing Unit (VPU) module for processing the setup of an H.324M call in the circuit switched network, an accounting server interworking module for transmitting charging and accounting data while working in conjunction with an accounting server (not shown) within the information provision system 10, etc. Such an information content interworking server may include a media gateway server connected to the transmitting or receiving terminal through a 3G Mobile Switching Center (MSC).

Further, the information provision system 10 may be provided with an advertisement interworking server. The advertisement interworking server may be included in the information management server 12, and may be connected to the servers of external advertisers, or media agents or media rep companies which sell information content corresponding to various types of advertisements of the advertisers, instead of the advertisers, to broadcasting stations or the like, or other advertising platforms which perform functions corresponding to those servers. In an embodiment, the advertisement interworking server may be configured to relay advertisements personally produced by advertisers and transfer the advertisements to the transmitting and/or receiving terminals.

Furthermore, the information provision system 10 may be provided with a gift transmission server. Such a gift transmission server may be connected to external gift transmission systems for providing gifts, such as mobile gift certificates, giftishow, gifticon, electronic money (e-money), and free gifts, and may be operated to transmit the corresponding gifts to the client terminals 20 and 30 depending on whether predetermined conditions are satisfied. The call control and management server 11 functions to establish and manage a media session for performing a communication service between the transmitting terminal 20 and the receiving terminal 30. The call control and management server 11 performs the function of establishing, controlling, and managing a call signal and a session so that the communication service, such as a voice call, chat, message transfer, video call, or video chat service, may be performed between the transmitting terminal 20 and the receiving terminal 30 based on the IP. A detailed method of establishing a call and a media session so that the communication service is performed will be described in detail below.

The above-described call control and management server 11 may include a plurality of modules which perform different functions, respectively. For example, the call control and management server 11 may include a Signaling Server (SS) module for processing an SIP call signal, connecting an SIP session to a media session, and performing an SIP proxy function, a Registration Server (RS) module for authenticating the terminals and managing the access addresses of the terminals, a Presence Server (PS) module for managing a buddy list of each client, and managing the state information of each buddy and providing real-time notification of the state information while working in conjunction with the RS module, a Push Notification Server (PNS) module for, when a client terminal does not execute the corresponding application program and a call cannot be connected, sending a push notification message to the terminal, and notifying the client that a request for call connection is received, thus allowing the application program to be executed on the client terminal, a Conference Control Server (CCS) module for generating conference resources and supporting a group call when the connection of a group call is required as in the case of a group text chat, a Session Boarder Controller (SBC) module for functioning to transmit/receive media streams between the terminals by solving a communication problem caused by a private network between the terminals, a Real-time Transport Protocol (RTP) control module for controlling the transmission of RTP streams of each terminal and transmitting RTP stream data to all other related participants in the case of a group call, a message control module for controlling the transfer of all various types of messages desired to be transferred to another party, such as a text message entered by a client, a voice message recorded via the microphone of a terminal, a memo, and a predetermined file, and a media gateway server interworking module for performing call signaling for connecting a call to a 3G receiving terminal and functioning as a media gateway.

The information management server 12 functions to manage information to be transmitted to at least one of the client terminals 20 and 30, for example, advertisement, coupon or event information. The information management server 12 may receive information content from an information content interworking server (not shown) for generating and managing information content such as that of an advertisement or event while working in conjunction with the information content interworking server. The information content interworking server may receive advertisement content or the corresponding advertisement information via system interworking with external advertisers, advertising agents, media rep providers, or the like, and may suitably provide various types of information including advertisements or the like depending on the classification of clients who use the client terminals 20 and 30. In this case, the classification of the clients who use the terminals may include the operation of targeting clients depending on the locations of terminals, the genders and age groups of use clients, etc. and adjusting the amount of exposure of information.

Further, the information management server 12 transmits information-related data about information to be provided to the client terminal 20 or 30 to at least one of the transmitting terminal 20 and the receiving terminal 30 either before a message session for a communication service is established between the transmitting terminal 20 and the receiving terminal 30 or while the communication service is performed. The client terminal 20 or 30 that received the information-related data provides information to the information display area of the display unit of the terminal based on the information-related data.

Meanwhile, the information management server 12 may be configured to, when the client terminal 20 or 30 accesses the information management server 12 and requests it to transmit information-related data, transmit the information-related data to the corresponding client terminal.

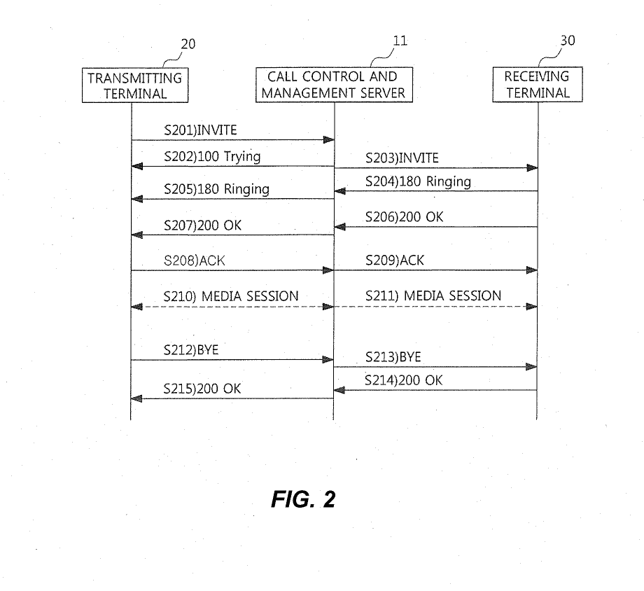

FIG. 2 is a flowchart showing a procedure for performing a communication service between the transmitting terminal 20 and the receiving terminal 30 via the information provision system 10 shown in FIG. 1.

Referring to FIG. 2, the transmitting terminal 20 first sends an INVITE message to the call control and management server 11 so as to request the connection of a call to the receiving terminal from the server 11 (S201).

Next, the call control and management server 11 sends a 100 Trying message to the transmitting terminal so as to notify the transmitting terminal that the call is being routed (S202). The call control and management server 11 inquires about the location information of the receiving terminal 30 and sends an INVITE message to the receiving terminal 30. If the location information of the receiving terminal is not valid, the call may be connected using, for example, push notification (S203).

When the receiving terminal receives an INVITE message, the receiving terminal rings, and sends a 180 Ringing message to the call control and management server 11 (S204).

Next, the call control and management server 11 transfers the 180 Ringing message to the transmitting terminal (S205).

Then, when the user of the receiving terminal 30 accepts the call connection request and responds to the request, a 200 OK message is transferred from the receiving terminal 30 to the call control and management server 11 (S206).

Next, the call control and management server 11 sends a 200 OK message to the transmitting terminal 20 (S207).

Thereafter, the transmitting terminal sends an Acknowledgement (ACK) message to the call control and management server 11, and establishes a media session required to perform the corresponding communication service (S208).

Then, the call control and management server 11 sends an ACK message to the receiving terminal 9. In this case, since all media sessions between the transmitting terminal and the receiving terminal are established, the terminals enter a state enabling the communication service (S210, S211).

Meanwhile, a call release procedure follows the same procedure regardless of the transmitting terminal and the receiving terminal. First, in order for the transmitting terminal 20 to terminate the call, the transmitting terminal 20 sends a BYE message to the call control and management server (S212).

Then, the call control and management server 11 requests the receiving terminal 30 to release the call by sending a BYE message to the receiving terminal 30 (S213).

Next, the receiving terminal 30 releases all of call connection resources and media session resources and sends a 200 OK message to the call control and management server 11 (S214).

Then, the call control and management server 11 releases all of call connection resources and media session resources and sends a 200 OK message to the transmitting terminal. When the 200 OK message is received from the call control and management server 11, the transmitting terminal releases all of call connection resources and media session resources (S215).

By way of this procedure, a communication service such as a voice call service, chat service, video call service, video chat service, or message transfer service which is based on IP may be performed between the transmitting terminal 20 and the receiving terminal 30 via the call control and management server 11. In this case, the information provision system according to the present invention transmits various types of information, such as advertisement or event information, to the client terminals 20 and 30 while performing this communication service.

Meanwhile, although not shown in detail in the drawing, the call control and management server of the information provision system according to the present embodiment may be configured to, when a group communication service such as a group text chat service is provided, generate conference resources, and control and manage a series of service procedures, such as the procedure of prompting a plurality of users to participate in a predetermined conference room, the procedure of allowing an additional participant to join a previously generated conference room, or the procedure of releasing an IP-based group communication call.

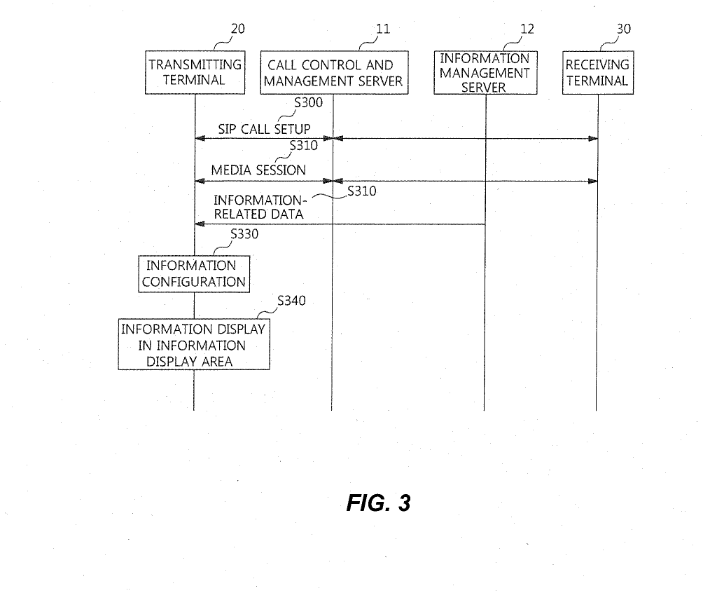

FIG. 3 is a flowchart showing an embodiment of a method of providing information when performing a communication service between the transmitting terminal 20 and the receiving terminal 30 via the information provision system 10 shown in FIG. 1, wherein a case where information is provided only to the transmitting terminal 20 is depicted.

Referring to FIG. 3, the transmitting terminal 20 and the receiving terminal 30 perform a communication service, such as a voice call service, chat service, video call service, video chat service, or message transfer service which is based on IP, using an SIP call setup procedure and a media session establishment procedure via the process such as that shown in FIG. 2 (S300, S310). During this procedure, the information management server 12 transmits information-related data about information to be provided to the transmitting terminal 20 to the transmitting terminal 20 (S320), and the transmitting terminal 20 that received the information-related data configures information to be displayed in the information display area of the display unit of the transmitting terminal 20 based on the received information-related data (S330), and displays the configured information in the information display area (S340).

In this case, although not shown in the drawing, the information management server 12 may be configured to, if the transmitting terminal 20 accesses the information management server 12 and requests the server 12 to transmit information-related data, transmit the information-related data to the transmitting terminal 20.

Further, although a configuration in which the information management server 12 transmits the information-related data to the transmitting terminal 20 during the performance of the communication service has been illustrated in FIG. 3, the information-related data may be previously pushed and transmitted to the transmitting terminal 20 at night or in a specific time span before the communication service is performed or, alternatively, the transmitting terminal 20 may access the information management server 12 and previously download and store the information-related data.

Further, the information that is provided to the transmitting terminal 20 may be an advertisement, and the information-related data may be advertisement data to be displayed in the information display area of the display unit of the transmitting terminal 20. The advertisement data may be provided in the form of, for example, text data, image data, video data, or the like. A message including such advertisement data may be transferred to the corresponding terminal by the information management server 12 working in conjunction with the call control and management server 11 under an SIP message method for SIP or a Message Session Relay Protocol (MSRP).

Meanwhile, in order to effectively provide a video advertisement, the information provision system according to the present embodiment may be configured to stop the provision of the corresponding video advertisement to minimize the amount of data used when the client terminal is in the state of accessing a network requiring expensive communication fees as in the case of 3G network access, and to push the video advertisement when the client terminal is in the state of accessing a low cost or free network, as in the case of WiFi network access. In this case, the client may use a video advertisement without paying additional cost, and thus the rate of use of the video advertisement may be increased.

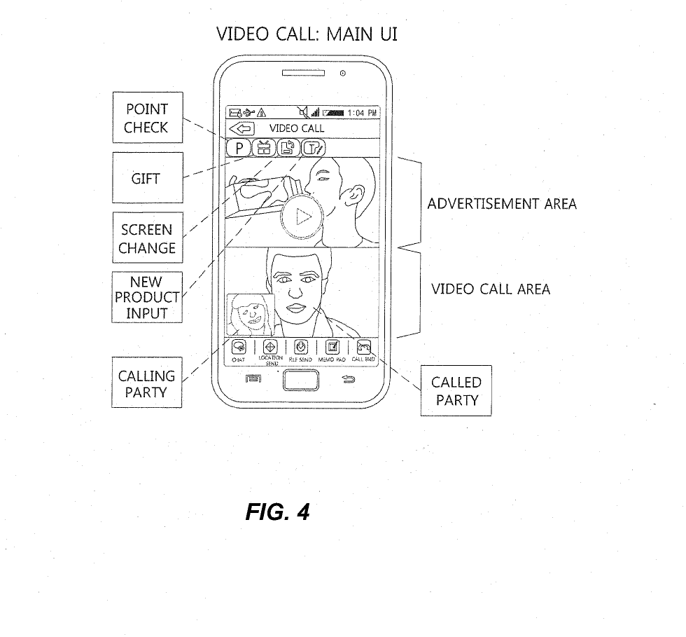

FIG. 4 is a diagram showing a screen when the information provision system according to the present embodiment provides an advertisement to the transmitting terminal 20.

Referring to FIG. 4, it can be seen that the area of the display unit of the transmitting terminal 20 is divided into an upper area implemented as an information display area (for example, an advertisement area), and a lower area implemented as a screen area (for example, a video call area) required to make a video call as a communication service. That is, the information provision system according to the present embodiment may be configured such that the screen is implemented as shown in FIG. 4, and thus a communication service, such as a video call service, may be performed in such a way that an advertisement is displayed in the upper information display area and a video of a calling party and a called party is displayed in the lower video call area.

In this case, the information provision system may provide a User Interface (UI), such as a button required to check points based on the use of an advertisement, a gift button required to present a product corresponding to the advertisement as a gift to the other party, a screen change button required for a change between upper and lower areas, or a new product input button required to link to a customer feedback receipt window for a new product, in the advertisement area.

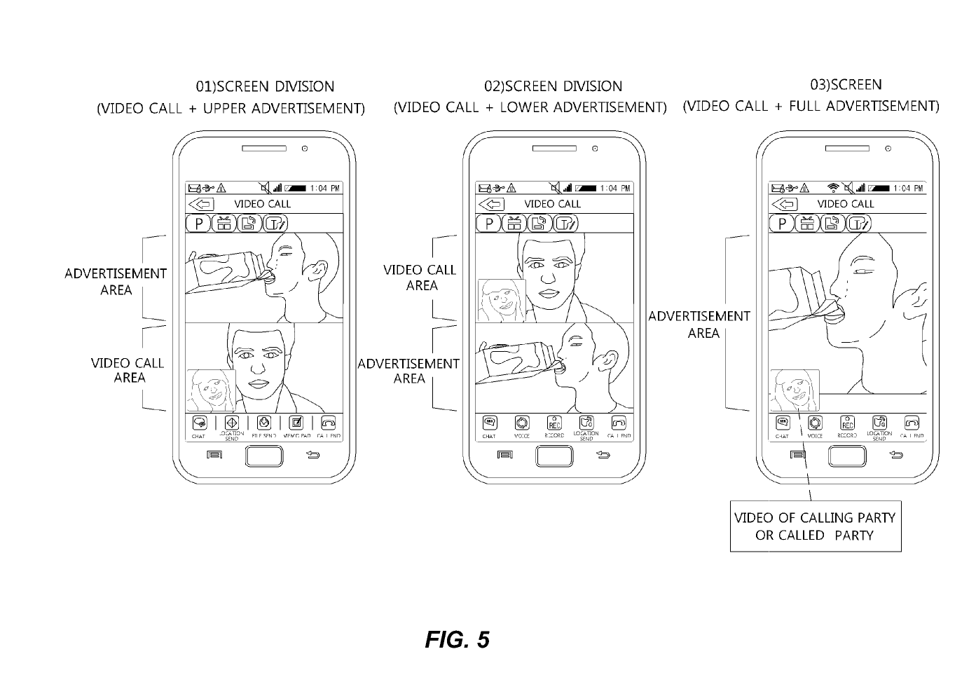

FIG. 5 is a diagram showing other examples of a screen when the information provision system according to the present embodiment provides an advertisement to the transmitting terminal 20. As shown in FIG. 5, of three screens displayed on the display unit of the client terminal, a left screen shows a case identical to that of FIG. 4, a center screen shows a case where an information display area (for example, an advertisement area) is displayed in the lower screen area of the display unit, and a right screen shows a case where the information display area is substantially displayed in the entire area of the screen of the display unit. In the case of the right screen, it can be seen that a screen for a video call, that is, a video call area, is implemented as a small size area in the lower left portion of the screen.

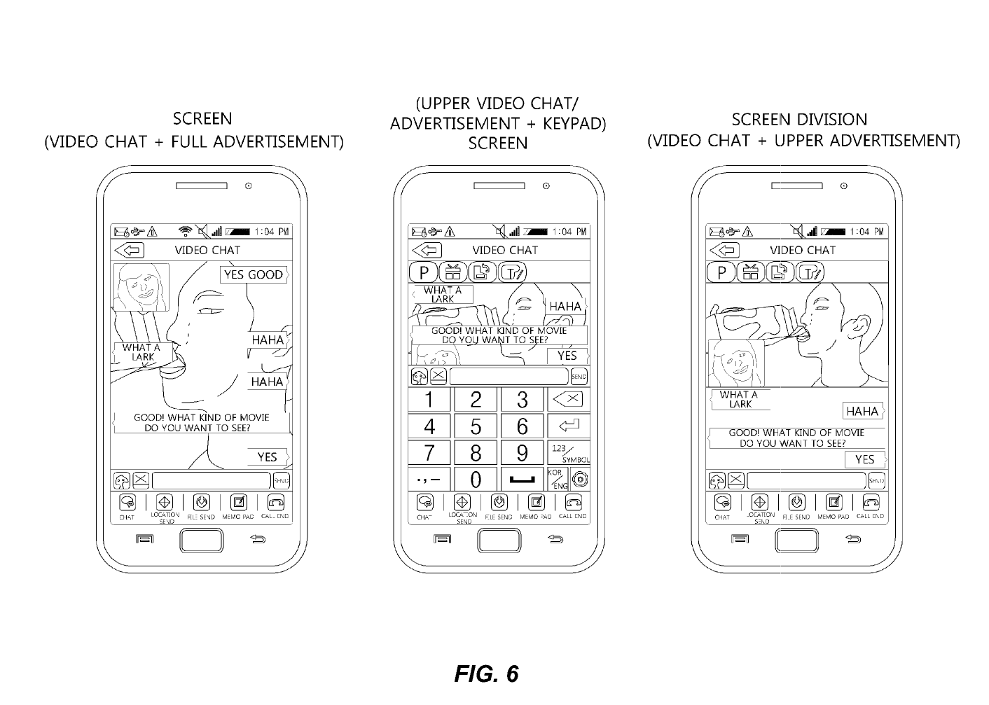

FIG. 6 illustrates other examples of a screen when the information provision system according to the present embodiment provides an advertisement to the transmitting terminal 20. The screen of FIG. 6 relates to a case where a video chat, normal text chat, or message transfer service is performed as a communication service, and shows a case where, of three screens displayed on the display unit of the client terminal, a left screen shows a case where an information display area (for example, an advertisement area) is provided as a background screen on the almost entire part of the display unit during chatting. A center screen and a right screen show cases where a screen area except the area of an input interface such as a keypad is provided as an information display area for a background screen-type advertisement when the user enters characters or numbers into the input interface to chat, wherein the input interface area of the screen is filled with a keypad and chat messages are displayed to overlap the upper information display area (see the center screen), and wherein, after the user enters characters or numbers using the keypad, or when the user waits to chat, the keypad disappears and chat messages move from the upper area to the lower area and are displayed independently of the upper information display area (see the right screen).

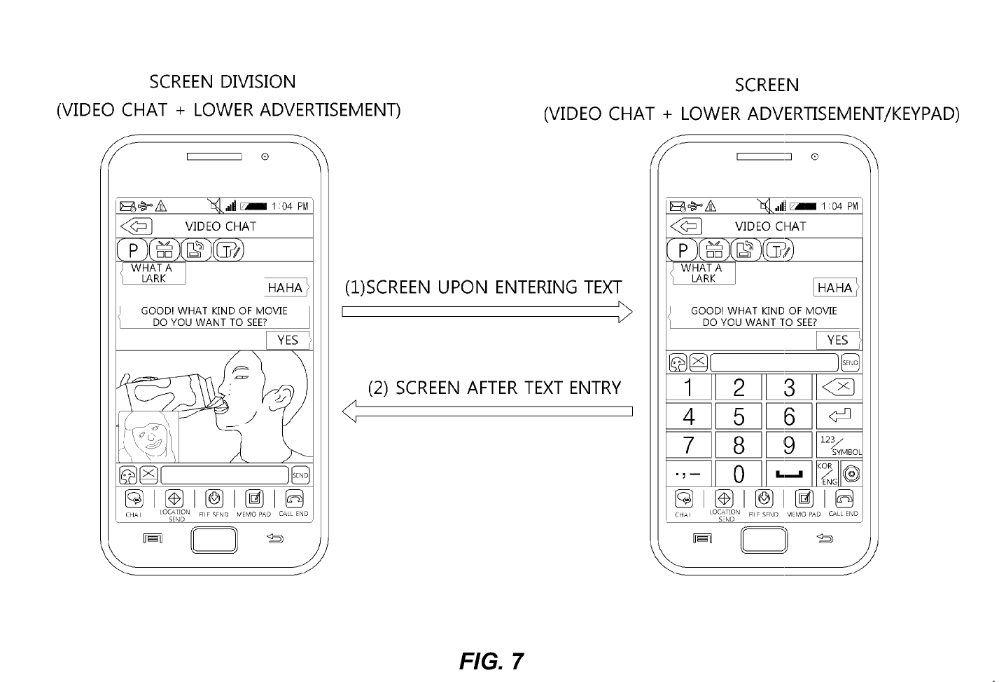

FIG. 7 is a diagram showing other examples of a screen when the information provision system according to the present embodiment provides an advertisement to the transmitting terminal 20. The screen of FIG. 7 shows a case where an information display area (for example, an advertisement area) is present at location at which a keypad that is an input interface appears and then disappears on the screen. That is, the left screen of FIG. 7 shows a screen after text has been entered, and a right screen shows a screen when text is being entered. In the case of FIG. 7, the information display area is repeatedly exposed and hidden by the input interface, that is, the keypad, thus obtaining the advantage of improving the effects of advertising.

In this case, the information display area of the client terminal may be configured using at least a part of the background screen of the user interface required to perform the corresponding communication service and may be configured to suitably activate or deactivate the information display area using the screen of the input interface.

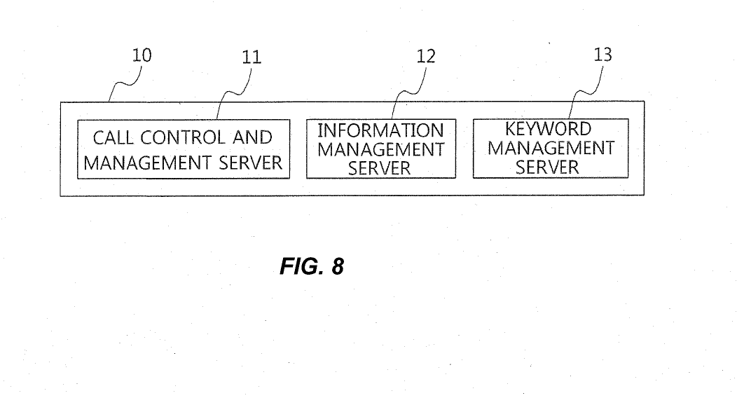

FIG. 8 is a diagram showing the configuration of a system for providing information to a client terminal when performing a communication service according to another embodiment of the present invention.

The information provision system 10 according to the present embodiment to be described with reference to FIG. 8 is substantially identical to the information provision system 10 described with reference to FIG. 1, except that a keyword management server 13 is further included.

Referring to FIG. 8, the keyword management server 13 functions to manage keywords and keyword-related information to be transmitted to the client terminal, and, for this function, works in conjunction with the advertisement exposure image processing module, the keyword advertisement exposure module, the screen control module, etc. of the client terminal.

Further, the keyword management server 13 transmits a keyword list and pieces of keyword information data corresponding to respective keywords included in the keyword list to each client terminal, either before a media session for a communication service is established between the transmitting terminal 20 and the receiving terminal 30 or while the communication service is performed.

In this case, the keyword list denotes list data in which specific words or phrases are collected, and the respective words or phrases included in the list data include information about a link to at least one image or video file contained in the keyword information data. The keyword information data includes text data, image data, video data, or combinations thereof corresponding to at least one word or phrase included in the keyword list.

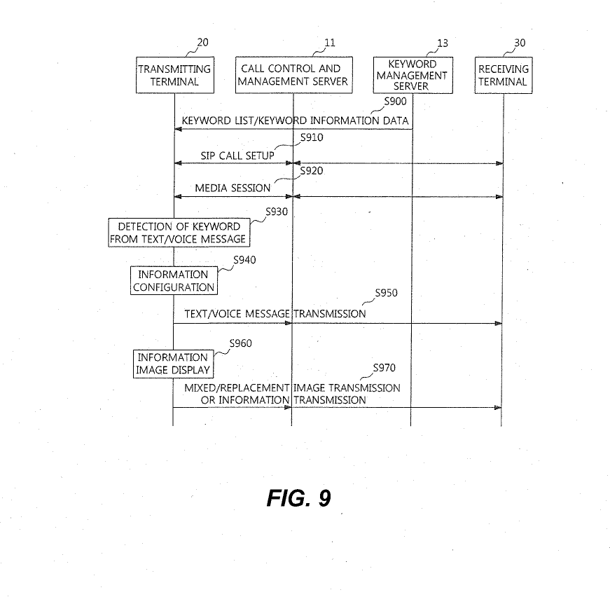

Each client terminal 20 or 30 that received the keyword list and the keyword information data is operated to detect a keyword included in the keyword list while performing the communication service of the client terminal based on the keyword list, configure a screen corresponding to the detected keyword based on the keyword information data, and display the corresponding information in the information display area of the display unit of the terminal. A detailed operation performed by this configuration will be described below with reference to FIG. 9 and subsequent drawings.

FIG. 9 is a flowchart showing an embodiment of an information provision method performed by the information provision system 10 shown in FIG. 8, and shows a case where, if the transmitting terminal 20 receives a keyword list and keyword information data from the keyword management server 13, and a keyword is detected, information corresponding to the keyword is displayed on the transmitting terminal 20.

Referring to FIG. 9, the transmitting terminal 20 receives a keyword list and keyword information data from the keyword management server 13 (S900). In this case, the term “keyword list” denotes data to be detected by the terminal and may be composed of pieces of text data, for example, “love”, “beer”, “Soju”, and “gift”. The term “keyword information data” denotes content data to be displayed on the terminal in correspondence with each keyword included in the keyword list and may be implemented as text data, image data, or video data. For example, for the keyword “love”, “heart”-shaped image data may be configured as keyword information data. As another embodiment, for the keyword “Soju”, a video of a Soju bottle may be configured as keyword information data. In this case, the keyword information data related to Soju may include Public Relations (PR) information of a specific company corresponding to Soju or a specific brand name of a specific product, for example, “Chamisul”. When a specific brand is directly exposed, an image of the corresponding brand product or a video advertisement of the brand product may be provided, wherein the video advertisement may be configured, for example, to be moved or shaken on the screen of the transmitting terminal 20 or configured to fill the entire information display area with a video advertisement of “Chamisul” and to play the video advertisement. In accordance with this procedure, when a specific keyword is recognized, a simple icon or a flash advertisement currently being displayed is replaced with a video advertisement corresponding to the keyword and this video advertisement is provided, thus improving concentration on the advertisement and communicative power, and consequently maximizing advertising effects.

Next, the transmitting terminal 20 sets up an SIP call and establishes a media session so as to perform a communication service with the receiving terminal 30 via the call control and management server 11 using the procedure such as that described in FIG. 2 (S910, S920).

Then, when the user of the transmitting terminal 20 creates a text or voice message while performing the communication service, the transmitting terminal 20 analyzes the text or voice message and determines whether any keyword included in the keyword list is present in the message (S930). For this, the transmitting terminal 20 must be provided with a character and speech recognition engine for detecting text and/or voice. Since the character and speech recognition engine is known in the prior technology, the present invention may use such technology without change, and this technology is not a core component of the present invention, and thus a detailed description thereof will be omitted.

Next, if, at S930, any keyword included in the keyword list is detected by the transmitting terminal 20, information to be displayed in the information display area is configured with reference to the keyword information data corresponding to the keyword (S940). For example, when the keyword “beer” is detected, image data representing “a beer bottle of a specific company (for example “Hite”) and a beer glass filled with beer” is searched for as the keyword information data corresponding to the keyword, and may be prepared for to be displayed on the display unit. For the prepared information image, both a form in which the keyword information data is mixed with the information display area and a form in which the keyword information data is displayed to replace the background of at least part or all of the screen of the terminal may be used. Preferably, of these forms, the keyword information data may be configured to replace the entire screen so as to improve advertising effects.

Next, the transmitting terminal 20 sends a text message or a voice message created by the user to the receiving terminal 30 (S950), and the information configured at S940 is displayed in the information display area as a mixed or replacement image (S960). Together with this, the transmitting terminal 20 may transmit the information configured at S940 to the receiving terminal 30 (S970). In this case, the transmitting terminal 20 may transmit only keyword information data corresponding to the keyword without transmitting the information configured at S940 as a mixed or replacement image to the receiving terminal 30. After receiving the corresponding information, the receiving terminal 30 may independently configure information and display the configured information in the information display area of the receiving terminal 30.

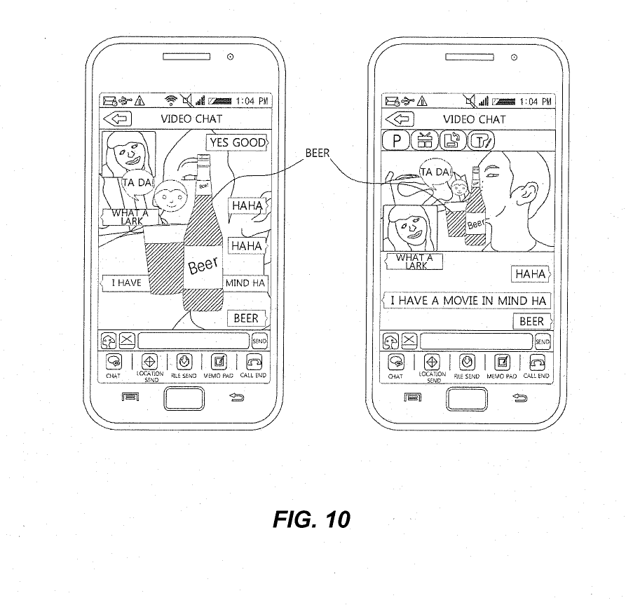

FIG. 10 illustrates a screen showing a case where an advertisement is provided as information to the display unit of the transmitting terminal 20 at S960 of FIG. 9.

Referring to FIG. 10, it can be seen that when a video chat is performed as a communication service, and “beer” is detected as a keyword, image data corresponding to beer is displayed to be mixed with chat messages in the entire or partial information display area of the screen.

As described above, the information display area is displayed by suitably using the screen of the user interface, wherein information corresponding to a keyword may be configured such that it is provided to be mixed with the existing information that is being provided. In this case, it is also possible to display only information based on the keyword without displaying the existing information that is being provided.

Meanwhile, in FIG. 9, although a configuration in which the keyword list and the keyword information data are transmitted to the transmitting terminal 20 at a previous step before the communication service is performed has been illustrated, it is apparent that the keyword and the keyword information data may be configured to be transmitted in real time to the transmitting terminal 20 during the performance of the communication service.

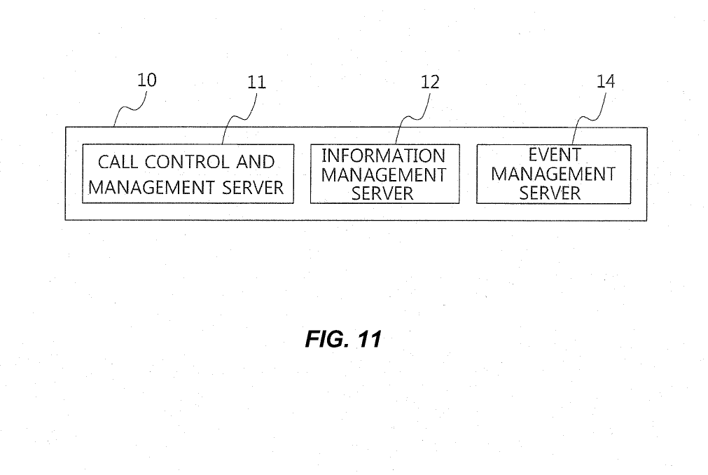

FIG. 11 is a diagram showing the configuration of a system 10 for providing information to a client terminal when performing a communication service according to a further embodiment of the present invention.

The information provision system 10 according to the present embodiment to be described with reference to FIG. 11 is substantially identical to the information provision system 10 described with reference to FIG. 1, except for a fact that an event management server 14 is further included.

Referring to FIG. 11, the event management server 14 may be coupled to or included in the information management server 12, and functions to manage an event allowing a user to take a specific action. For this, the information management server 12 may be configured to transmit event data together with information-related data upon transmitting the information-related data to the transmitting terminal 20 at S320 of FIG. 3.

In this case, the event data which is data including the details of the event may include condition information, such as time at which the event is displayed on the display unit of the terminal and the duration of display, and may be implemented to be displayed on the display unit of the client terminal if a predetermined execution condition for the event is satisfied.

For example, a specific time span, a specific region, a specific keyword, or the like may be designated as the execution condition of the event data. When a specific time is designated, event data allows the details of the event to be automatically displayed in the information display area if the corresponding time is reached. Further, the details of the event may have a request that requests the user to take a specific action, such as “enter the word ‘beer’ three times” as an execution condition. If the user takes the action depending on this condition, information such as details of participation in the event and user information may be transferred from the client terminal to the event management server 14. In this case, the event management server 14 may receive the corresponding information, record it in an event database (DB), and execute processing, such as the determination of whether the user won the event and the distribution of advertising profit. Further, the event management server 14 may process a reward procedure, such as providing free gifts or distributing profit while working in conjunction with a separate server.

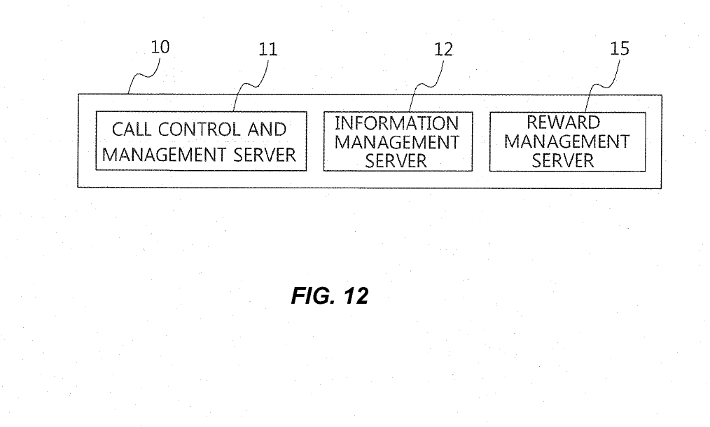

FIG. 12 a diagram showing the configuration of a system for providing information to a client terminal when performing a communication service according to yet another embodiment of the present invention.

The information provision system 10 according to the present embodiment to be described with reference to FIG. 12 is substantially identical to the information provision system 10 described with reference to FIG. 1, except for a fact that a reward management server 15 is further included.

Referring to FIG. 12, the reward management server 15 may be coupled to or included in the information management server 12 and functions to determine and manage the levels of rewards to be provided to users depending on the information exposure levels, event participation levels, or event execution levels of the users. For this, the reward management server 15 may collect pieces of information from each client terminal via the call control and management server 11 of the information provision system 10 and store the information in a DB or the like.

In this case, an information exposure level includes the type, the exposure time and/or the number of exposures of information (for example, an advertisement) provided to the client terminal, event participation time and/or the number of participations in an event, event execution time and/or the number of executions of the event, etc. Further, the reward management server 15 may be configured to differentially distribute part of profit created from the provision of information to the corresponding client depending on the information exposure level of the client based on the information use data collected from the client terminal. Furthermore, the reward management server 15 may be configured to collectively perform point management, event participation management, the management of keyword exposure points, etc. for respective clients, and to automatically deliver various types of free gifts, such as mobile certificates, to the mobile phone numbers of clients in corresponding months when the points of the clients reach predetermined points. It is apparent that profit distributed to each client may be delivered in the form of, not only mobile certificates, but also cache transferred to the account of the client, e-money, text coupons, or the like.

For example, in order to determine the information exposure level of a client, a point assignment scheme may be adopted. In this case, the reward management server 15 may accumulate cumulative time points related to times for which the client uses the information between a chat start time and a chat end time, keyword points automatically assigned when a specific keyword is generated during chatting, event points assigned when the client participates in each event, and typing points assigned when the client types an advertising phrase, as points for each client, analyze the rate of profit depending on the quantity of advertisements by an advertiser, the number of clients, and correlations with preset reward policies, and determine the degree of points or profit to be assigned to the corresponding client.

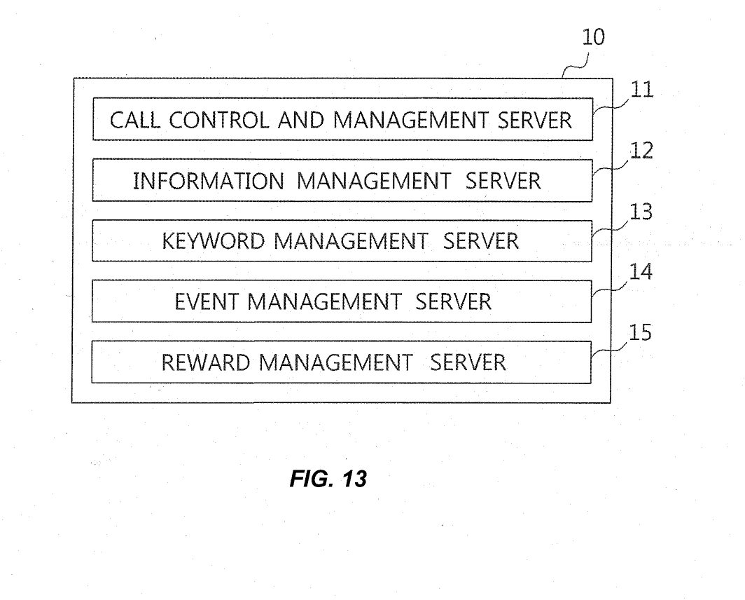

FIG. 13 is a diagram showing the configuration of a system 10 for providing information to a client terminal when performing a communication service according to still another embodiment of the present invention.

Referring to FIG. 13, the information provision system 10 according to the present embodiment is characterized in that it includes a keyword management server 13, an event management server 14, and a reward management server 15, in addition to the information provision system 10 OF FIG. 1.

The keyword management server 13 is substantially identical to the keyword management server described with reference to FIGS. 8 to 10, the event management server 14 is substantially identical to the event management server described with reference to FIGS. 11 and 12, and the reward management server 15 is substantially identical to the reward management server described with reference to FIG. 13.

In the information provision system 10 according to the present embodiment, the reward management server 15 may be configured to additionally determine the points and/or profit distribution of clients depending on the exposure levels of keywords and/or keyword-related information provided by the keyword management server 13 to the respective clients, or the levels of participation in and/or execution of events provided by the event management server 14 to the clients. In such a case, profit based on the use of information (for example, advertisement exposure) is distributed even to each client, so that the exposure of an advertisement attributable to the use of a keyword by the client, or attributable to the participation in or execution of events may be positively induced, thus maximizing the effects of advertising to clients to increase the sales of products, and activating economic activity based on the promotion of product sales.

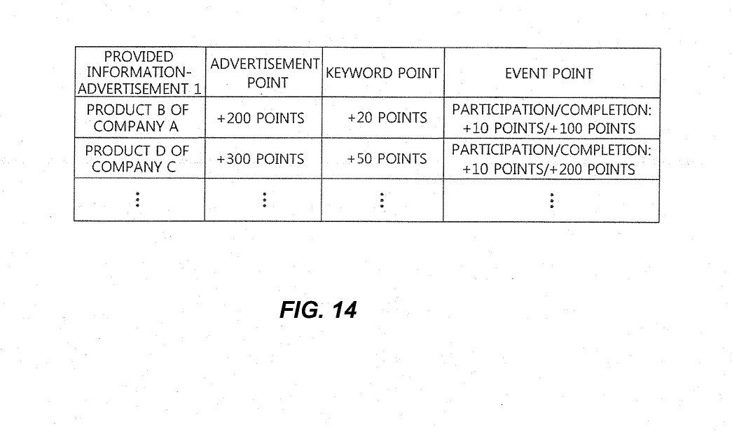

FIG. 14 is a diagram showing the principle of the principal operation of the information provision system of FIG. 13, which shows an example of references for advertisement points, keyword points, and event points of individual products of a predetermine group (advertisement 1) depending on the policies of advertising programs agreed upon with advertisers.

Referring to FIG. 14, the reward management server 15 may be configured to reward clients with predetermined points and/or profit depending on the type, form, etc. of information exposed to the clients based on a reference table stored in the DB of the system. For example, the reward management server 15 may be configured to assign 200 points to a client when product B of company A is displayed in the information display area (for example, advertisement area) of a client terminal, assign 20 points to the client when a specific keyword is included in a text or voice message and information corresponding to the keyword is displayed on the client terminal, and assign 10 points to the client when the client participates in a specific event or assign 100 points when the client completes the execution of the specific event.

In this way, in the present embodiment, an advertisement, a coupon or an event may be provided in the form of a predetermined image or video file having a link thereto so that, when information such as the advertisement, coupon, or event is touched on the client terminal 20 or 30, the client terminal 20 or 30 goes to the homepage of the advertisement or event. Further, the information provision system 10 collects the amount of exposure of and the rate of clicking on the corresponding information using the number of exposures of an advertisement or event or the number of visits to a homepage, based on touching or the like, processes the amount of exposure and the rate of clicking, generates report or statistical data, and provides the generated report or statistical data to advertisers or advertising agents, thus allowing advertisers or advertising agents to suitably distribute contributory parts of sales profit based on the exposure of information to clients or the use of information to the provider of the information provision service according to the present embodiment and to clients who use the service.

Although the present invention has been described with reference to preferred embodiments, it is apparent that the present invention is not limited to the above embodiments. For example, it is apparent that the present invention may be performed even during a multipoint communication service, such as “one-to-many” or “many-to-many” communication service, as well as a “one-to-one” communication service. Further, the present invention may be applied even to a case where a client terminal uses a mobile communication network, such as a 3G network, and in such a case, it requires equipment such as a media gateway for connecting a call between the network of the IP-based communication service and the mobile communication network. Of course, this is known in the prior art, and thus a detailed description thereof will be omitted.

1. An information provision system for providing information to at least one of client terminals including a transmitting terminal and a receiving terminal when performing a communication service, comprising:
a call control and management server for establishing and managing a media session for performing a communication service between the transmitting terminal and the receiving terminal; and
an information management server for managing information to be transmitted to at least one of the client terminals,
wherein the information management server transmits information-related data about information to be provided to the corresponding client terminal to at least one of the transmitting terminal and the receiving terminal, either before the media session for the communication service is established between the transmitting terminal and the receiving terminal or while the communication service is performed, and
wherein the client terminal that received the information-related data provides the information to an information display area of a display unit of the client terminal based on the information-related data.

2. The information provision system of claim 1, wherein the communication service is at least one of voice call, chat, video call, video chat, and message transfer services based on Internet Protocol (IP).

3. The information provision system of claim 1, wherein the information management server receives a request for transmission of the information-related data from the client terminal, and transmits the information-related data to the client terminal.

4. The information provision system of claim 1, wherein the information display area of the client terminal area is at least a part of a background screen of a user interface of the client terminal.

5. The information provision system of claim 1, wherein the client terminal is configured such that an input interface included in a user interface of the client terminal appears and then disappears on the user interface, and the information display area is an area in which the input interface disappears.

6. The information provision system of claim 1, wherein the information provided to the client terminal is an advertisement, and the information-related data includes advertisement data.

7. The information provision system of claim 1, further comprising a keyword management server for managing keywords and keyword-related information to be transmitted to the client terminal,
wherein the keyword management server transmits a keyword list and pieces of keyword information data corresponding to respective keywords included in the keyword list to at least one of the client terminals either before the media session for the communication service is established between the transmitting terminal and the receiving terminal or while the communication service is performed, and the client terminal that received the keyword list is operated to detect a keyword included in the keyword list while performing the communication service of the client terminal based on the keyword list, configure information corresponding to the detected keyword based on the keyword information data, and display the corresponding information in the information display area of the display unit of the terminal.

8. The information provision system of claim 7, wherein the terminal that displays the information in the information display area of the display unit transmits corresponding keyword information data to a terminal of another party.

9. The information provision system of claim 7, wherein, of the client terminals including the transmitting and receiving terminals, the terminal that displays the information in the information display area of the display unit transmits image information mixed or replaced with information about the keyword, or information-related data corresponding to the keyword to a client terminal of another party.

10. The information provision system of claim 1, further comprising an event management server coupled to the information management server and configured to manage an event allowing a user to take a specific action,
wherein the information-related data includes event data allowing the user to take the specific action.

11. The information provision system of claim 1, further comprising a reward management server coupled to the information management server and configured to collect information about use of information-related data by a terminal user of at least one of the transmitting terminal and the receiving terminal and to process a reward to the user based on collected use information.

12. The information provision system of claim 11, further comprising at least one of a keyword management server coupled to the information management server and configured to provide information-related data including a keyword list and keyword information data to the client terminal, and an event management server coupled to the information management server and configured to provide information-related data including event data that allows the user to take a specific action to the client terminal,
wherein the reward management server processes a reward to the user based on at least one of use information of the information-related data based on at least one keyword included in the keyword list and use information of the information-related data based on participation in an event.
